(19) United States
(12) Patent Application Publication
(10) Pub. No.: US 2008/0067113 A1
(43) Pub. Date: Mar. 20, 2008

(54) SIFTING SCREEN AND METHOD OF MANUFACTURE

(76) Inventor: Nashat N. Helmy, West Bloomington, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/772,612

(22) Filed: Jul. 2, 2007

Related U.S. Application Data
(60) Provisional application No. 60/806,389, filed on Jun. 30, 2006.
(60) Provisional application No. 60/822,336, filed on Aug. 14, 2006.

(51) Int. Cl. B07B 1/46

(52) U.S. Cl. 209/405

(57) ABSTRACT

A sifting screen and method of manufacturing such a screen. Segments of the screen are provided with a unique cross-sectional structure to afford various desirable characteristics to such an implement. The cross section includes, typically, a wire frame, a hard plastic encapsulation layer and an elastomeric outer layer.

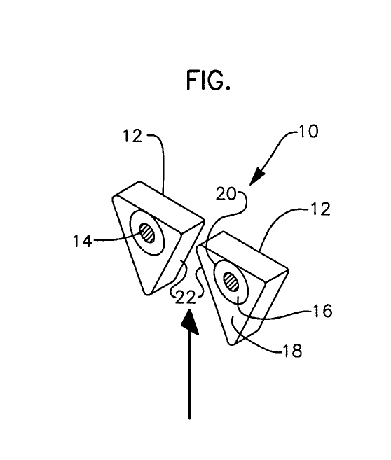

### CROSS-REFERENCE TO RELATED APPLICATIONS

This is a regular application filed under 35 U.S.C. § 111(a) claiming priority, under 35 U.S.C. § 119(e) (1), of provisional application Ser. No. 60/806,389, previously filed Jun. 30, 2006 under 35 U.S.C. § 111(b) and provisional application Ser. No. 60/822,336, previously filed Aug. 14, 2006 under 35 U.S.C. § 111(b).

### TECHNICAL FIELD

The present invention deals with sifting screens. It is a sifting screen grid to be manufactured to tolerance and of good quality.

### BACKGROUND OF THE INVENTION

A number of different types of screen designs for use in screens for sizing and sifting aggregate are known in the prior art. For example, woven wire defining a grid or matrix comprises one type of screen available. Such a woven wire matrix is stretched over a bucker bar support arrangement to hold the screen under significant tension.

Another type of screen which is known in the art is one, typically comprising multiple abutting modules made of, or coated with, elastomeric material. Such modules are, as known in the art, typically punched plates or molded segments made of a material such as rubber or polyurethane.

Both of the types of screen designs described above have significant drawbacks. There are a number of factors within the context of which a screen design can be evaluated. First, a significant factor which must be considered is the open area through which material being processed can pass. In the formation of a screen, the apertures formed can limit the open area to a point where jamming or clogging may occur. Certainly, a design of this nature would be undesirable in that, from a long-term economic perspective, a high degree of inefficiency might be encountered. If the lowermost, for example, of three sifting decks became clogged because of limited open space, the total sifting operation may well have to be terminated, at least for a limited period of time, until the clogging is corrected. In accomplishing this with respect to a third sifting deck, removal of first and second decks might be necessary. Again, an inordinate amount of time during which the system would be down may well be encountered.

A second factor which must be considered is durability or longevity. Because of the highly abrasive environment in which sifting screens operate, deterioration can, in the case of some types, be quite fast. Not only does this involve increased cost for replacement, but, again, downtime can be significant.

A third factor which is typically considered is the cost of the replacement screen segment or overall screen. In some cases, replacement costs can be quite high.

A final factor which pervades all the other factors considered is total economic cost. For example, wire might be relatively inexpensive per linear foot. One must, however, consider other costs. Mere replacement cost, while important, is not the end of the analysis which must be performed. An owner/operator of such machines must consider the frequency with which a screen must be replaced. For example, if one type of screen is relatively inexpensive to replace but must, because of lack of durability, be replaced ten times as often as another, more expensive construction, in the long run, the more expensive structure might be less costly. Further, cost measured in man-hours must also be considered. Labor performed in repair can be a very significant factor. Further, downtime can be aggravated, as previously discussed, because of difficulty in reaching and repairing or replacing a damaged screen or segment thereof.

When applying these factors to prior art structures, one concludes that a woven wire structure is excellent in terms of open area. In terms of durability or longevity, however, woven wire tends to be very poor. And, while in terms of mere price of the material comprising the screen wire tends to be the least expensive, in terms of total economic realities, it must be replaced frequently and overall economic cost can be significant. As will be able to be seen then, there are many costs that must be borne if one chooses to use a woven wire screen.

In terms of open area, a punched or molded screen made of, or coated with, polyurethane, rubber or another elastomer leaves something to be desired. In the molding or punching process, there can be burrs which, to one degree or another, can occlude the apertures through which the medium being processed passes. Further, while a screen made of such materials is typically quite durable, it is very expensive. In a total economic sense, therefore, such screens may not be desirable.

The art of the design of sifting screens reveals no type of screen that addresses all of the factors discussed above. While some of the factors generate good marks with regard to a particular type of screen, such a screen is deficient in other respects making it, in many instances, economically unfeasible.

The present invention is a screen designed for use in sifting, sizing and classifying sieves which solve problems of the prior art. It is of a unique construction which offers a proposed solution to problems of the prior art.

### SUMMARY OF THE INVENTION

The present invention is a composite screen including three components. There is an inner frame or grid which is, typically, made of woven wire having a specific design, tolerance and tight weave. A middle layer of a hard plastic adheres to the woven wire frame. Finally, an elastomeric outer layer which is made of rubber or a polyurethane elastomer encapsulates the frame and plastic middle layer.

The frame is woven to a specific tolerance, size, opening pitch and crimping criteria. The middle layer is made of a hard plastic designed to encapsulate the frame either by a coating process or a dipping process. This plastic or hard, high durometer synthetic material must adhere well to the frame layer as well as to the elastomeric outer layer. This is accomplished by either heating and dipping the frame or skeleton in a liquid plastic or liquid polymer, and then curing the middle layer on the metal frame in such a way so as to not to destroy its ability to adhere to the primer on the metal frame or to the elastomeric outer layer.

The temperature of the frame is made to vary between 350° F. to 650° F. before coating. The liquid polymer is heated to a temperature of between 80° F. to 120° F. After coating the frame, the two-component matrix must be maintained at a temperature of not less than 120° F. and not more than 220° F. The liquid polymer layer must have a jelling stage and be able to continue in this form without completely reacting and curing before introducing the polymeric elastomeric outer layer to the matrix. Upon introducing the outer polymeric elastomer layer, a reaction takes place at the surface between the middle jelling layer and the outer layer.

The introduction of the outer layer and the middle layer should occur within a viscosity range to provide for the formation of a tapered angle as shown in the FIGURE. This process should provide for a design of a triangular, square, rectangular or trapezoidal cross-section of webbing. This can be accomplished by direct formation of each strand including a frame section using mechanical means, such as molding, drawing through a special die, or by physically rotating the entire matrix at a certain speed while applying an air flow current in a direction to provide formation of a tapered wall. The preferred method is to employ mechanical means such as a special molding implement or a special forming die to provide a triangle shape.

The entire process of making the webbing by weaving or welding a frame portion, adding the middle layer and encapsulating the entire matrix should result in a screen opening with a tolerance of I 0.001″ so that the entire jelled matrix can be formed in a tapered opening with the screen opening having a tolerance between 0.001″ to 0.003″.

To finish the matrix comprising all layers, it is cured on a mount to allow the material to completely react and fuse without altering the opening size or the opening tolerance.

Finally, the entire cured webbing is allowed to cool while maintaining its integrity and keeping the opening tolerance.

It will be understood that this disclosure, in many respects, is only illustrative. Changes may be made in details, particularly in matters of shape, size, material, and arrangement of parts without exceeding the scope of the invention.

### DESCRIPTION OF THE DRAWING FIGURE

The drawing FIGURE is a perspective view illustrating two adjacent portions of a screen webbing in accordance with the present invention, the segments of webbing being shown in cross-section.

### DETAILED DESCRIPTION OF THE INVENTION

Referring now to the drawing FIGURE, wherein like reference numerals denote like elements throughout the several views, the FIGURE illustrates the construction of webbing segments 12 for a screen device 10 in accordance with the present invention. It will be understood that, while portions of only two segments are illustrates, an overall screening apparatus will comprise a grid of many sections and intersecting cross-sections.

Referring again to the drawing FIGURE with regard to the structure of a segment, central-most in the segment is an inner frame portion 14 which is, typically, made of a woven wire material. This wire is provided with a specific design, tolerance and weave, depending upon the size of the sieve and its intended purposes. The wire frame component 14 also is designed with a particular desired opening size, pitch and crimping criteria. It will be understood that intersections of the sections and cross-sections can be maintained by weaving, welding or simply made tightly adjacent one another.

A middle layer 16 surrounds the metal wire frame 14. The middle layer 16 is typically made of a hard plastic which adheres to the frame segments 14. The hard plastic medium is designed so as to encapsulate the frame either by a coating process or a dipping process. The plastic chosen is of a high durometer and is of a synthetic material that adheres well to the frame layer. Further, a plastic material is selected which will adhere similarly to an elastic outer layer described hereinafter.

The plastic layer can be made of either a hard rubber or hard urethane, in either case having a durometer ranging between 40-60. Another alternative for forming the inner core is a liquid PVC which, when it hardens, attains similar characteristics of hard rubber or hard urethane. PVC would be used because of its lesser cost.

The function of the inner core hard plastic layer is, in part, to render the segments of the matrix stiff and rigid. At the same time, however, a small measure of stretchability is maintained.

The adherence of the plastic layer 16 to the frame 14 is accomplished by either heating or dipping the frame or skeleton in a liquid plastic or a liquid polymer. The middle layer 16 is then cured, to a degree, so that adherence to the frame 14 is not diminished.

During the process thus described, the temperature of the frame is made to be maintained at a temperature of 350° F. to 650° F., before coating. The liquid polymer is heated to a temperature of between 80° F. to 120° F. After the frame has been coated, the two-component matrix is maintained at a temperature of not less than 120° F. and not more than 220° F. This is done to maintain the liquid polymer in a jelled state and to maintain it in this form without complete reaction and curing for introduction of the polymeric elastomeric outer layer 18.

Upon introducing material to form the outer elastomer layer 18, a reaction takes place at interfacing surface 20 of the jelled middle layer 16 and the outer layer 18 now applied. To facilitate the reaction, the introduction of the outer layer 18 to the surface of the middle layer 16 should occur within a viscosity range in order to provide for the formation of a tapered surface 22 on each opposing webbing segment 12 as illustrated in the FIGURE. The process should provide for a design which is triangular, square, rectangular or trapezoidal in cross-section. Controlling the shape can be accomplished by direction formation of each segment by use of mechanical means. Such means include molding, drawing through a special die, or physical rotation of the entire matrix at a speed while concurrently applying a flow of air which impinges upon the framework in order to accomplish formation of the tapered walls. The preferred method for so shaping the matrix is to employ mechanical means such as special molding implements or a special forming die.

The entire forming process of making the webbing 10 should result in a module having screen openings with a tolerance of I 0.001″. As the module segments taper downward, the jelled matrix can be formed by tapering the openings to a tolerance of between 0.001″-0.003″. After the appropriate dimensions are achieved, the matrix is then cured on a mount to allow final reaction and fusion. This is facilitated and enabled to occur in a manner such that the opening sizes will not vary.

The concluding step is to encourage complete curing of the webbing 10 and allowing the webbing to cool. Again, structural integrity is maintained and the opening tolerances are kept.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. Sifting segments of a sieve, comprising:
(a) a generally central wire frame member running axially through the segment;
(b) a plastic layer encapsulating said wire frame, said plastic layer being made of a material which, when cured, adheres tightly to said wire frame; and
(c) an outer elastomeric layer encapsulating said plastic layer and securely bonded thereto, said elastomeric layer defining an outwardly facing surface.
